(19) United States
(12) Patent Application Publication
(10) Pub. No.: US 2025/0384481 A1
(43) Pub. Date: Dec. 18, 2025

(54) METHOD AND SYSTEM FOR PERSONALIZED MATCHING OF COSMETIC PRODUCTS TO A SUBJECT'S SKIN AND/OR HAIR

(71) Applicant: MENOW LTD, Ramat Gan (IL)

(72) Inventors: Coralie EBERT, Rehovot (IL); Hilla BEN-HAMO, Ramat Gan (IL)

(21) Appl. No.: 18/994,941

(22) PCT Filed: Jul. 23, 2023
(86) PCT No.: PCT/IL2023/050762

§ 371 Date: Jan. 15, 2025

Related U.S. Application Data
(60) Provisional application No. 63/369,521, filed on Jul. 27, 2022.
(60) Provisional application No. 63/417,109, filed on Oct. 18, 2022.

(51) Int. Cl. G06Q 30/0601; A45D 44/00; G06N 7/01; G06Q 30/0282

(52) U.S. Cl. CPC G06Q 30/06431; A45D 44/005; G06N 7/01; G06Q 30/0282; G06Q 30/06211; G06Q 30/0631; A45D 2044/007

(57) ABSTRACT

There is provided herein a computer-implemented method for personalized matching of cosmetic, skincare and/or haircare products to a subject's skin/hair, the method including: obtaining input data of the subject, extracting a plurality of subject-specific skin/hair and skin/hair associated features/parameters from the input data, obtaining a name of a cosmetic, skincare and/or haircare product and/or a list of ingredients in a cosmetic, skincare and/or haircare product selected by the subject, applying a Quantitative Structure-Activity Relationship (QSAR) algorithm on the ingredients to obtain molecular and/or structural properties thereof, applying an AI algorithm on the plurality of extracted subject-specific skin/hair and skin/hair-associated features/parameters and on the molecular and/or structural properties of the skincare, haircare and/or cosmetic product to determine a degree of matching of the selected cosmetic product to the subject's skin/hair.

### TECHNOLOGICAL FIELD

The present disclosure generally relates to computer implemented method and system for personalized matching of cosmetic products to a subject's skin, in particular artificial intelligence (AI)-based method and system for personalized matching of cosmetic products to a subject's skin and/or hair, that are adapted to the needs of mass production.

### BACKGROUND

Even though the average US woman spends 313$ a month for it, only 10% of women are satisfied with their skin. This is not surprising considering the pandemic of skin conditions (⅓ of the population according to the World Health Organization), the high degree of skin diversity and the lack of true biological personalization.

Moreover, the very high number of skincare products (over 10000 facial creams are available on amazon), makes finding a skincare product that fits a particular person's skin, an incredibly difficult task. This problem is augmented by the fact that skin types are typically categorized into a few categories only (dry skin, oily skin, combination skin, skin with acne, sensitive skin and aging skin). However, many people suffer from other skin conditions that cannot be grouped into the existing categories.

There therefore remains a need for personalized skin care solutions that take into account a large plurality of skin and skin-associated features, which solutions are still adapted to the needs of mass production and cost efficiency.

### SUMMARY

There is provided herein an AI-based platform for mass-scale personalized matching of cosmetics and skincare products, that truly takes into account skin diversity as well as other factors, thereby enabling recommending the right skin product and regimen to a specific customer.

Advantageously, the platform also provides a user-friendly interface, optionally in conjunction with diagnostic kits, for following up on previously provided recommendations, which follow-up is used for both improving the matching for the specific user but also for continuous learning and/or improvement of the platform itself.

The AI-based platform advantageously tools to integrate the raw ingredients of the cosmetic and skincare products, the general and medical background of the user, physical properties of a subject's skin and environmental conditions, in order to maximize the system's predictive power. In addition, the system may also take into account an emotional status of the user to further hyper-personalize the user experience and maximize the user's engagement and retention.

According to some embodiments, there is provided a computer-implemented method for personalized matching of a cosmetic/skincare/haircare product to a subject's skin/hair, the method comprising:
obtaining, via a user interface associated with a processor, input data of the subject, the input data comprising one or more of: answers to a questionnaire, environmental data, medical background, demographic data, one or more images of the subject's skin/hair, or any combination thereof;
extracting a plurality of subject-specific skin/hair and skin/hair associated features/parameters from the input data using text and/or image analysis algorithms, obtaining, via input to the user interface, a name of a cosmetic/skincare/haircare product and/or a list of ingredients in a cosmetic, skincare, haircare product selected by the subject, applying a Quantitative Structure-Activity Relationship (QSAR) algorithm on the ingredients in the selected cosmetic/skincare/haircare product, to obtain molecular and/or structural properties thereof,
applying, using the processor, an AI algorithm on the plurality of extracted subject-specific skin/hair and skin/hair-associated features/parameters and on the molecular and/or structural properties of the skincare/haircare/cosmetic product to determine a degree of matching of the selected cosmetic product to the subject's skin and/or hair; and transmitting/displaying, via the user interface, the determined degree of matching the selected skincare, haircare, and/or cosmetic product.

According to some embodiments, the questionnaire is presented to the user via the user interface and the answers stored on a memory associated with the processor.

According to some embodiments, the one or more images of the subject's skin/hair are uploaded to the processor via the user interface.

According to some embodiments, the skin/hair features/parameters are selected from: oiliness, redness, dryness, skin diseases, inflammation of the skin, pigmentation, acne, scarring, rosacea, sunburns, wrinkles, skin elasticity, photoaging, seborrhea, dandruff, scalp-related issues, hair damages, hair dryness, hair oiliness, and any combination thereof. Each possibility is a separate embodiment.

According to some embodiments, the skin and/or hair-associated features/parameters are selected from: skin tone, age, gender, ethnicity, facial hair, hair thickness, hair type, hair color, emotions and any combination thereof. Each possibility is a separate embodiment.

According to some embodiments, the method further comprises updating the questionnaire based on the identified skin/hair features and/or skin/hair associated features.

According to some embodiments, the user data further comprises a microbiome profile and/or DNA profile of the subject.

According to some embodiments, the user data further comprises a pH and/or oiliness measured for the subject's skin.

According to some embodiments, the environmental parameters are selected from one or more of temperature, sun radiation, air pollution, humidity, UV index and any combination thereof. Each possibility is a separate embodiment.

According to some embodiments, the medical parameters are selected from one or more of allergies, medical history, menstrual cycle, pregnancy and any combination thereof. Each possibility is a separate embodiment.

According to some embodiments, the AI algorithm is a deep learning algorithm. According to some embodiments, the deep learning algorithm is a Bayesian network.

According to some embodiments, the cosmetic product is a facial skincare product.

According to some embodiments, the input data comprises answers to a questionnaire and one or more of: environmental data, medical background, demographic data, one or more images of the subject's skin, or any combination thereof. Each possibility is a separate embodiment.

According to some embodiments, there is provided a computer-implemented method for matching cosmetic, skincare and/or haircare products to a subject's skin/hair, the method comprising:
obtaining, via a user interface associated with a processor, input data of the subject, the input data comprising one or more of: answers to a questionnaire, environmental data, medical background, demographic data, one or more images of the subject's skin/hair, or any combination thereof;
extracting a plurality of subject-specific skin/hair and skin/hair associated parameters/features from the input data using text and/or image analysis algorithms; applying, using the processor, an AI algorithm on the plurality of extracted skin/hair and skin/hair associated features/parameters, to assign the subject into one or more skin/hair bio-individuality clusters;
inputting the one or more skin/hair bio-individuality clusters into a database of cosmetic, skincare and/or haircare products to output a list of cosmetic, skincare and/or haircare products that match the subject's skin; and
transmitting/displaying, via the user interface, the list of matching cosmetic, skincare and/or haircare products to the subject.

According to some embodiments, the one or more skin type clusters indicates recommended and/or unrecommended skin/hair product ingredients. According to some embodiments, the method is further configured to transmit to the subject the list of recommended and/or unrecommended skin/hair product ingredients.

According to some embodiments, the cosmetic products in the database are classified using a Quantitative Structure-Activity Relationship (QSAR) algorithm on the ingredients thereof.

According to some embodiments, the AI algorithm is further configured to determine a degree of matching of the listed-as-matching cosmetic, skincare and/or haircare products and transmitting the degree of matching to the subject.

According to some embodiments, the method further comprises obtaining, via a user provided input, one or more product categories of interest, and wherein the clustering is category specific.

According to some embodiments, the one or more product categories are selected from cleansing products, serums, moisturizers, sunscreens, masks, conditioners, fragrances, make-ups, concealers, and any combination thereof. Each possibility is a separate embodiment.

According to some embodiments, the skin features/parameters are selected from: oiliness, redness, dryness, skin diseases, scalp-related issues, inflammation of the skin, pigmentation, acne, scarring, sunburns, atopic dermatitis, rosacea, seborrhea, dandruff and any combination thereof.

According to some embodiments, the skin-associated features/parameters are selected from: skin tone, age, gender, age, ethnicity, facial hair, hair color, hair type, emotions and any combination thereof.

According to some embodiments, the AI algorithm is a deep learning algorithm. According to some embodiments, the deep learning algorithm is a Bayesian network.

According to some embodiments, the cosmetic product is a facial skin care product.

According to some embodiments, the input data comprises answers to a questionnaire and one or more of: environmental data, medical background, demographic data, one or more images of the subject's skin, or any combination thereof. Each possibility is a separate embodiment.

According to some embodiments, there is provided a platform for personalized matching of a cosmetic/skincare/haircare product to a subject's skin/hair, the platform comprising:
a user interface, the user interface configured to:
   receive via upload or user input, input data of the subject, the user data comprising one or more of: answers to a questionnaire, environmental data, medical background, demographic data, one or more images of the subject's skin/hair, or any combination thereof; and
   receive via upload or user input, a name of a cosmetic/skincare/haircare product and/or a list of ingredients in a cosmetic/skincare/haircare product,
a processor, associated with the user interface, the processor configured to:
   extract a plurality of subject specific skin/hair and skin/hair associated features/parameters from the input data using text and/or image analysis algorithms,
   derive molecular properties of the skincare, haircare and/or cosmetic product by applying a Quantitative Structure-Activity Relationship (QSAR) algorithm thereon,
   apply an AI algorithm on the plurality of extracted skin/hair and skin/hair-associated features/parameters and on the derived molecular properties of the skincare, haircare and/or cosmetic product; and
   transmit/display, via the user interface, a degree of matching of the selected skincare, haircare and/or cosmetic product to the subject's skin/hair.

According to some embodiments, there is provided a platform for matching cosmetic/skincare/haircare products to a subject's skin/hair, the platform comprising:
a user interface, the user interface configured to:
   receive via upload or user input, input data of the subject, the user data comprising one or more of: answers to a questionnaire, environmental data, medical background, demographic data, one or more images of the subject's skin/hair, or any combination thereof; and
a processor, associated with the user interface, the processor configured to:
   extract a plurality of subject-specific skin and skin associated parameters/features from the input data using text and/or image analysis algorithms;
   apply an AI algorithm on the plurality of extracted skin/hair and skin/hair-associated features/parameters, to assign the subject into one or more skin/hair bio-individuality clusters;
   input one or more of the assigned bio-individuality cluster into a database of cosmetic, skincare, cosmetic and/or haircare products to output a list of matching cosmetic, skincare and/or haircare products and/or a list of recommended ingredients of cosmetic, skincare and/or haircare products; and
   transmitting, via the user interface, the list of suitable cosmetic, skincare and/or haircare products and/or list of recommended ingredients to the subject.

According to some embodiments, the database of cosmetic/skincare/haircare products comprises cosmetic/skincare/haircare products analyzed by applying a Quantitative Structure-Activity Relationship (QSAR) algorithm thereon, to derive molecular properties thereof.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF THE FIGURES

The invention will now be described in relation to certain examples and embodiments with reference to the following illustrative figures so that it may be more fully understood.

FIG. 1 schematically illustrates the basic architecture of the herein disclosed platform for personalized matching of cosmetic/skincare products to a subject's skin, according to some embodiments;

FIG. 2 schematically illustrates the use of an AI-model for personalized matching of cosmetic/skincare products to a subject's skin, according to some embodiments;

FIG. 3 schematically illustrates the user side of the AI-model for personalized matching of cosmetic/skincare products to a subject's skin, according to some embodiments;

FIG. 4 schematically illustrates the product side of the AI-model for personalized matching of cosmetic/skincare products to a subject's skin, according to some embodiments;

FIG. 5 schematically illustrates the data that has been used to build the model.

FIG. 6 schematically illustrates direct integration of the host microbiome data into the AI-model for personalized matching of cosmetic/skincare products to a subject's skin, according to some embodiments;

FIG. 7 schematically illustrates indirect integration of the host microbiome data into the AI-model for personalized matching of cosmetic/skincare products to a subject's skin, according to some embodiments;

FIG. 8 schematically illustrates the integration of image-based feedback from the user into the AI-model for personalized matching of cosmetic/skincare products to a subject's skin, according to some embodiments;

FIG. 9 is an exemplary questionnaire presented to a user during intake;

FIG. 10 schematically illustrates the extended use of the hereindisclosed platform for skincare regimen recommendation, monitoring and feedback, and research and development;

FIG. 11, schematically illustrates the hereindisclosed platform for matching of cosmetic/skincare products to a subject's skin from an end-user's perspective, according to some embodiments;

FIG. 12, schematically illustrates clustering users into bio-individuality clusters for different product categories, according to some embodiments;

FIG. 13 is an illustrative flowchart of a computer implemented method for personalized matching of a skincare/cosmetic product to a subject's skin, according to some embodiments;

FIG. 14 is an illustrative flowchart of a computer implemented method for assigning a subject to a bio-individual skin-type cluster, according to some embodiments;

FIG. 15 is an illustrative flowchart of a computer implemented method for classification of cosmetic/skincare products, according to some embodiments.

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

For convenience, certain terms used in the specification, examples, and appended claims are collected here. Unless otherwise defined, all technical and scientific terms used herein have the same meaning as commonly understood by one of ordinary skills in the art to which this invention pertains.

According to some embodiments, disclosed herein is computer-implemented method and/or AI-based platform for personalized matching of a cosmetic/skincare product to a subject's skin.

According to some embodiments, the hereindisclosed computer-implemented method and AI-based platform advantageously enable mass-scale personalized matching of cosmetics and skincare products, that truly takes into account skin diversity as well as other factors, thereby enabling recommending the right skin product and regimen to a specific customer.

According to some embodiments, the platform applies big-data analytics.

According to some embodiments, the platform analyzes each consumer according to one or more of the below listed factors:
1. Physical parameters of the subject's skin (such as dryness, pigmentation, acne, color, scarring, oiliness and the like), for example by applying image analysis on images captured by the user.
2. Environmental factors, such as weather, sun radiation, air pollution, humidity, UV-index and the like.
3. Medical background, such as allergies, background diseases/treatment, menstrual cycle, pregnancy and the like.
4. User demographics, such as age, gender, ethnicity, time spent outdoor etc.
5. Emotions as for example derived from image analysis and/or crawling of the subject's social media profiles.
6. Diagnostic kits that the consumer may optionally receive to check at home one or more of the following:
   a. DNA-the consumer can take a test or share the results of a previously conducted test (e.g. 23&Me/MyHeritage/Ancestry). Additionally or alternatively the user may conduct designated gene specific kits.
   b. Microbiome—testing the microbiome of the subject's skin.
   c. Oiliness and pH tests.

According to some embodiments, cosmetic and skin care products may be analyzed based on one or more of the following data:
1. Ingredients list—The herein disclosed AI-based platform analyzes each ingredient in the cosmetic/skincare product, to provide a prediction on both bioactivities and targets, using a QSAR (Quantitative Structure-Activity Relationship). Those predictions can then be projected to a computational model of skin diversity, allowing to recommend to each user his/her optimal skin regimen.
2. Additional data such as the molecular composition of plant extracts and other ingredients previously conducted in-vitro and/or clinical trials.
3. Information regarding texture and fragrance of the products.

According to some embodiments, a Protein-Protein Interaction (PPI) model may be applied on the data. According to some embodiments, the PPI model is built by applying a dedicated model (e.g. a seeded Bayesian model) on transcriptomic data obtained from the EMBL database for different conditions (skin diseases, ethnicity, age, gender etc.), According to some embodiments, the nodes (edges/pathways) obtained by the model represent conditional probabilities (for example, the probability of having dry skin if you are smoking). This allows for sophisticated predictions that are easily interpretable, and also intuitively integrates real world data for training purposes (machine learning). Non-proteomic elements, such as physical and morphological properties of the skin, ingredients, and input coming from questionnaires, are also integrated into the virtual skin model by applying Natural Language Processing (NLP) models and experts' knowledge thereon.

Advantageously, since the model is probabilistic, it can be used to reconstruct missing data and for giving relevant predictions/explanations to the end user. Non-limiting examples of such predictions includes predicting that the user has a mutation on a specific gene, an upregulated pathway or a specific type of bacteria present on his/her skin.

According to some embodiments, part of the information from the model from a specific user can be used to reconstruct some of the non-apparent data and enhance the predictive power of image-based predictions. That is, the imaging of the skin may be analyzed holistically to retrieve both skin diagnostic data, but also demographic data and general data (such as skin tone, gender, age, facial hair and the like) and emotions.

Advantageously by combining all the above-described data with information obtained from other sources (e.g. questionnaires, information gathered from social networks and the like) missing data can be reconstructed and the accuracy of the matching platform improved. According to some embodiments, the subject may receive a questionnaire, e.g. via a user-interface of the platform. According to some embodiments, the questionnaire may be a standard questionnaire presented to all users, via the platform. According to some embodiments, the questionnaire may be personalized for example based on the physical/morphological features of the subject's skin derived from the imaging, the medical/medicinal background of the subject, the environmental background and/or demographic data. According to some embodiments, the subject may initially receive a standard questionnaire and then later, based on the additional data received obtain a follow-up personalized questionnaire.

According to some embodiments, and as set forth above, the platform may also include a microbiome layer. This layer may be used as an interface between the cosmetic compounds and the skin. According to some embodiments, the microbiome is simulated using a reaction metabolic network, where each node is annotated using an Reaction Molecular Signature (RMS), optionally based on an rRNA 16S analysis. Advantageously, by taking into account, the microbiome of the skin, the cosmetic/skin care products recommended to the subject may be tailor made to accustom the microbiome and/or to change/improve the microbiome signature of the subject's skin in order to restore the balance.

As a non-limiting example, an individual having an increased presence of S. aureus (a staphylococcus which has linked to an increased risk of developing atopic dermatitis) may be recommended to use cosmetic/skin care products with ingredients that disfavor, inhibit or otherwise reduce the presence of S. aureus. As another non-limiting example, an individual having a decreased population of Actinobacteria and/or Propionibacterium, which has been linked to a decreased proportion of long chain fatty acids and as a result to a decrease in long chain ceramides, leading to a loss of skin elasticity and wrinkles, may be recommended to use cosmetic/skin care products with ingredients that favor, induces growth of or otherwise increase Actinobacteria and/or Propionibacterium populations, such as to recommend cosmetic/skincare products rich in ceramides and/or free fatty acids.

According to some embodiments, integration of the subject's skin microbiome data may be used to identify indirect effects of a cosmetic/skincare product on the subject's skin. For example, skin care products including lactose and glycerol, may be transformed into lactic acid and/or succinic acid by the skin microbiota, both of which have a different impact on the skin (e.g., on atopic dermatitis) than the compounds from which they originated.

According to some embodiments, the herein disclosed AI-based platform is further configured to classify subject's into bio-individuality clusters that regroup specific skin care needs of a subject, thereby providing a personalized yet cost effective solution. Accordingly, an ad hoc tool is provided, which tool enables end users to buy cosmetic/skincare products based on thir bio-individuality cluster classification. According to some embodiments, the AI platform also classifies cosmetic/skincare products based on their degree of matching to a specific bio-individuality cluster, regardless/independently of the source/brand of the product. According to some embodiments, the bio-individuality cluster may be further classified into sub-categories based on the type of cosmetic/skincare product (e.g., cluster for cleansing products, cluster for serum products, cluster for moisturizer etc.), thereby achieving a hyper-personalized solution for different products of the skincare routine.

According to some embodiments, the clusters are defined using a Bayesian probabilistic framework that regroups and analyzes data coming from both the user and the ingredients of the cosmetic/skincare product. According to some embodiments, based on the data, the model clusters different skin needs in terms of pathways that need to be activated/inhibited in order to achieve optimal skin health. It is understood that these clusters may group individuals having different skin types, but identical skin needs, into a same cluster. As a non-limiting example, a woman over 60 with skin prone to inflammation and pigmentation issues may be classified into a same cluster as a teenager suffering from acne.

According to some embodiments, the herein disclosed AI-based platform may be further configured to output a formulation and/or ingredient list that address the needs of a specific bio-individuality cluster.

According to some embodiments, the herein disclosed AI-based platform may be further configured to output a predicted effect of a cosmetic/skin care product. Advantageously, this may enable to label cosmetics and skin-care products with the cluster name to which it is matched, thereby enabling users to purchase products that are likely to have the best effect on their skin.

According to some embodiments, the platform includes an App, or an online or in-store assessment tool that enables users to determine to which cluster their skin belong. According to some embodiments, the assessment tool further enables to associate a to a number of clusters, based on the type of skin-care products in question. Advantageously, this allows to hyper-personalized the skincare routine of a subject using only a limited number of products.

As used herein, the term “platform” may refer to user applications (Apps), websites or dedicated computer programs that via a user interface enables to upload data, interact with users, and provide skincare recommendations to users. According to some embodiments, the platform may include a user interface (e.g. an App/website) for communication with a user. According to some embodiments, the platform may include a processor and an associated memory, the memory programmed with executable instructions for execution of the hereindisclosed method.

As used herein, the terms “user”, “subject” and “individual” may be used interchangeably and refer to any person using the herein disclosed platform to obtain personalized cosmetics, skincare or haircare recommendations.

As used herein, the term “skincare product” refers to products intended to moisturize, care and/or cleanse a subject's skin. Non limiting examples of skincare products include: creams, oils, cleansers, serums, sunscreens, and moisturizers. Each possibility and combination of possibilities is a separate embodiment. According to some embodiments, the skincare product may be a facial skincare product. According to some embodiments, the skincare product may be or include a nutraceutical or nutraceutical composition. According to some embodiments, the skincare product may be a food supplement.

As used herein, the term “haircare product” refers to products intended to cleanse, care and/or treat a subject's hair. Non limiting examples of haircare products include: shampoos, conditioners, serums, oils, masks, and hair lotions. Each possibility and combination of possibilities is a separate embodiment. According to some embodiments, the haircare product may be or include a nutraceutical or nutraceutical composition. According to some embodiments, the haircare product may be a food supplement.

As used herein, the term “cosmetic” and “cosmetic product” may be used interchangeably and refers to products intended to beauty a subject's skin. Non limiting examples of cosmetic products include: fragrances, tinted creams, concealers and/or make-up. According to some embodiments, the cosmetic product may be a facial cosmetic product.

As used herein, the term “skin/hair features/parameters” refers to physical properties of the skin and hair. Non limiting examples of skin features/parameters include skin elasticity and texture, skin tone, skin susceptibility to photoaging, skin radiance, oiliness, redness, dryness, skin diseases, inflammation of the skin, pigmentation, acne, scarring, skin pH, microbiome, hair thickness, hair length, hair type, hair dryness, scalp-related issues and any combination thereof. Each possibility and combination of possibilities is a separate embodiment.

As used herein, the term “skin/hair associated parameters” refers to parameters that may influence the health, type, and condition of a subject's skin and/or hair. Non limiting examples of skin associated parameters include, geographic location, water quality, air pollution, UV index, sport activities, diet, age, gender, menstrual cycle, pregnancy, smoking, medical history, drugs, time spent outdoor, time spent in airconditioned environment, water consumption, daily stress levels and any combination thereof. Each possibility and combination of possibilities is a separate embodiment.

According to some embodiments, the method/platform is configured for optimizing skin and hair health. As used herein, the term “skin/hair health” refers to vitality associated skin and/or hair features. That is, even if a cosmetic product is evaluated, it is evaluated for its impact on the health of the skin and/or hair and not necessarily its beauty. That is, while the herein disclosed platform and method may also recommend products in terms of their beauty features (matching to the tone of the skin, the color of clothing etc.) such beauty evaluation is an additional feature, second to the health evaluation.

As used herein, the term “user interface” and “UI” may be used interchangeably and refer to the point at which human users interact with a computer, website or application.

According to some embodiments, the using platform comprises uploading and/or inputting user data. Non-limiting examples of user data includes answers to a questionnaire, environmental data, medical background, demographic data, images of the subject's skin and/or hair, microbiome data, genetic data, gene expression data and any combination thereof. Each possibility and combination of possibilities is a separate embodiment. According to some embodiments, skin and skin associated parameters/features may be extracted from the data for example by applying NLP models, bioinformatics models, and/or image analysis algorithms thereon. According to some embodiments, at least 2, 3, 4 or five types of input data are uploaded and/or inputted.

According to some embodiments, the user may also input a name (and optionally brand) of a selected skincare, haircare or cosmetics product and/or a list of ingredients found in a selected skin care, hair care or cosmetics product. Each possibility is a separate embodiment. According to some embodiments, inputting the name and/or a list of ingredients found in a selected skin care, hair care or cosmetics product comprises scanning a QR-code found on the product, picturing the product and/or the list of ingredients, or inputting it as text. Each possibility is a separate embodiment. According to some embodiments, the list of ingredients may be retrieved automatically by the platform based on the inputted name of the product and optionally also the brand and/or price of the product.

According to some embodiments, the input data may further include an emotional status of the subject. According to some embodiments, the emotional status may be derived from image analysis and/or answers to a questionnaire.

According to some embodiments, upon retrieval or inputting of the ingredient list, an API call may automatically be made to apply an algorithm that is configured to retrieve/determine molecular and/or structural properties of the ingredients. A non-limiting example of such algorithm include Quantitative Structure-Activity Relationship (QSAR) algorithms. According to some embodiments, the output of the QSAR may then serve as input to the AI algorithm of the platform.

According to some embodiments, the user data and the product data may then be inputted into the AI algorithm of the platform to output a degree of matching of the selected cosmetic product to the subject's skin and hair. The degree of matching (e.g. in the form of a score) may then be presented to the user, via the user interface.

According to some embodiments, there is provided a computer-implemented method and platform for clustering individuals into one or more skin bio-individuality clusters.

As used herein, the term “one or more” bio-individuality clusters may refer to 1, 2, 3, 4 or more clusters. Each possibility is a separate embodiment.

As used herein, the term “bio-individuality cluster” may refer to groups of individuals having same, essentially same or similar skincare and/or haircare needs.

As used herein, the term “same” and “essentially” may refer to individuals whose skincare and/or haircare needs are sufficiently similar for them to purchase the same cosmetic/skincare/haircare products.

As used herein, the term “similar” refers to individuals which for some product categories have same, or essentially same, skincare and/or haircare needs, while for other product categories have different skincare and/or haircare needs.

As used herein, the terms “category”, “product category”, “haircare category” and “skincare category” may be used interchangeably and may refer to grouping of cosmetics/skincare/haircare products based on their function. Non-limiting examples of product categories include serums, cleansers, sunscreens, moisturizers, and the like.

According to some embodiments, the bio-individuality cluster is category specific. For example, an individual may belong to one bio-individuality cluster for serums and to another for sunscreens.

According to some embodiments, the method and the platform is further configured for matching a cosmetic/skincare/haircare products to a subject based on the bio individuality cluster to which he/she is assigned. Each possibility is a separate embodiment.

According to some embodiments, the method and the platform is further configured for inputting the assigned skin type cluster into a database of cosmetic/skincare/haircare products so as to output a list of suitable cosmetic/skincare/haircare products. Each possibility is a separate embodiment. According to some embodiments, the cosmetic/skincare/haircare products are classified based on the properties for example by applying an QSAR algorithm on the ingredient list of the product, as essentially described herein. Each possibility is a separate embodiment.

According to some embodiments, the method and the platform is further configured for transmitting, via the user interface, the list of suitable cosmetic/skincare/haircare products to the subject. Each possibility is a separate embodiment.

As used herein, the terms “approximately”, “essentially” and “about” in reference to a number are generally taken to include numbers that fall within a range of 5% or in the range of 1% in either direction (greater than or less than) the number unless otherwise stated or otherwise evident from the context (except where such number would exceed 100% of a possible value). Where ranges are stated, the endpoints are included within the range unless otherwise stated or otherwise evident from the context.

As used herein, the singular forms “a,” “an” and “the” include plural referents unless the context clearly dictates otherwise.

As used herein, “optional” or “optionally” means that the subsequently described event or circumstance does or does not occur, and that the description includes instances where said event or circumstance occurs and instances where it does not.

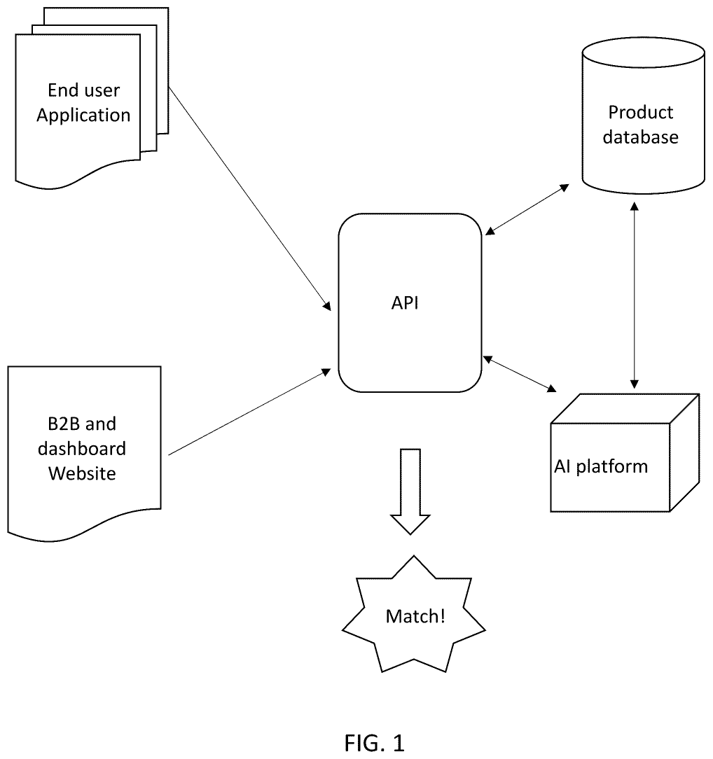

Reference is now made to FIG. 1, which schematically illustrates the basic architecture of the herein disclosed platform for personalized matching of cosmetic/skincare/haircare products to a subject's skin, according to some embodiments. On the left side of the figure, is the front end of the platform which may include end user Apps and/or websites through which the user can answer to questionnaires and input his/her input data, (such as, but not limited to uploading one or more of: images, medical data, demographic data, test results and the like. Each possibility is a separate embodiment.), or through which stores can manage their user interactions. Once the data has been uploaded, API calls to the back end enables matching of the subject's skin type (based on the input data) to cosmetic products, based on their ingredient lists, as further elaborated herein.

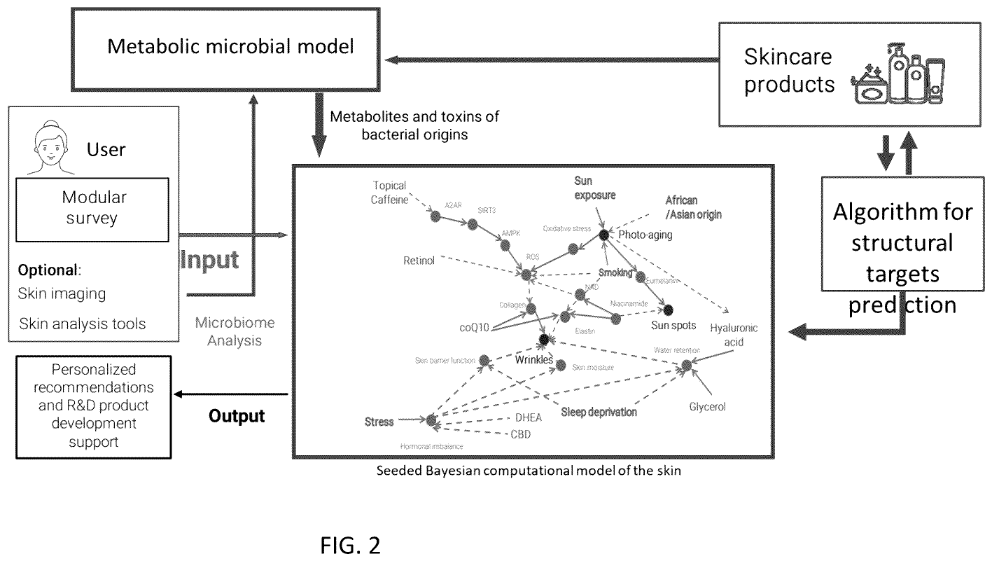

Reference is now made to FIG. 2, which schematically illustrates the use of an AI-model, here a Seeded Bayesian computational model of the skin for personalized matching of cosmetic/skincare/haircare products to a subject's skin, according to some embodiments. The model enables integration of user input and product information using a Bayesian network (in the middle). The nodes of the network may include one or more of user input data (survey results, images of the skin/hair, biological tests etc.), proteins/genes known to be linked to skin and/or hair health, and product identification. Each node can have different properties associated to it (for example over-expressed or under-expressed for a protein). The model may include multiple layers. A first layer of prediction may be executed on the ingredients of the cosmetic products, before integration into the Bayesian network, for example by using a Quantitative Structure-Activity Relationship (QSAR) algorithm that takes into account the molecular properties and structure of the ingredients. Another layer that may be included is a microbiome analysis which may be based on biological tests and identification of associated metabolites and/or toxins of microbial origin.

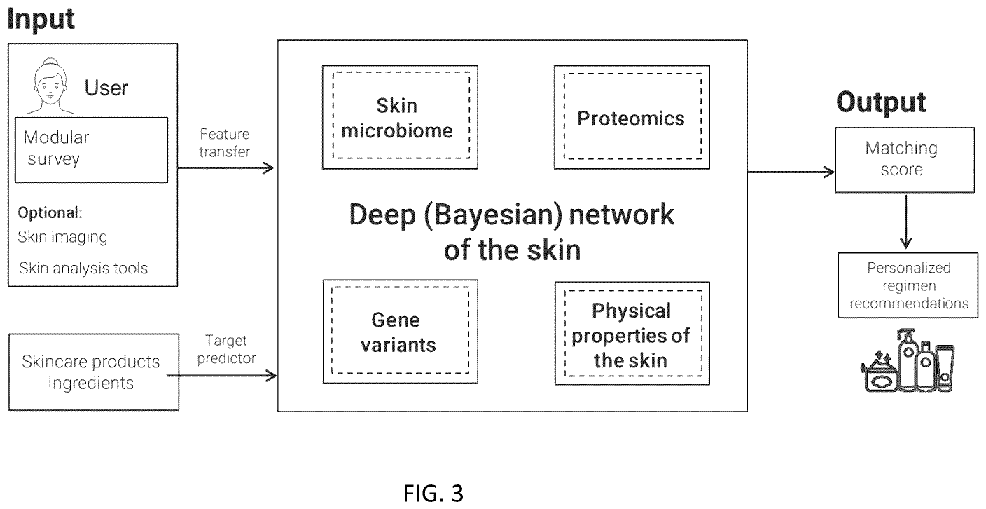

Reference is now made to FIG. 3, which is an optional detailed representation of the user-side of the herein disclosed AI-model for personalized matching of cosmetic/skincare/hair products to a subject's skin/hair, according to some embodiments. The AI-model (here Bayesian network) is trained on data such as transcriptomic data, skin microbiome, gene variants and physical properties of the skin, from which data features are extracted. According to some embodiments, this side of the model may output a personalized recommendation for a subject's cosmetic/skincare/haircare regimen.

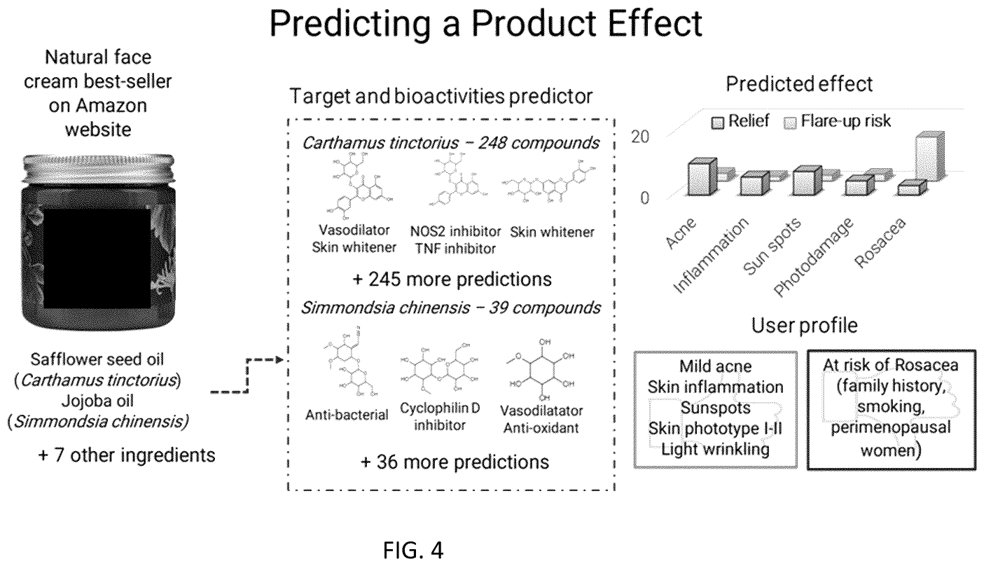

Reference is now made to FIG. 4, which is an exemplary presentation of the product-side of the herein disclosed AI-model for personalized matching of cosmetic/skincare/haircare products to a subject's skin/hair, according to some embodiments. The prediction of a product's effect (here a natural face cream best-sellers on amazon website) is based on its ingredients (here 9 plant extracts) For each extract, the molecular composition (structure/function) is extracted from relevant databases. Based on this data, a prediction of the biological activity of each extract is made, which prediction is subsequently used to determine the impact (positive and adverse) the extract is likely to have on a variety of skin indications. For example, this product was determined to be effective for mild acne due to its predicted anti-inflammatory and anti-bacterial activities, but can potentially cause flare-ups of rosacea. Thus, this product would not be recommended to people who are at risk of developing rosacea or to people who already have it.

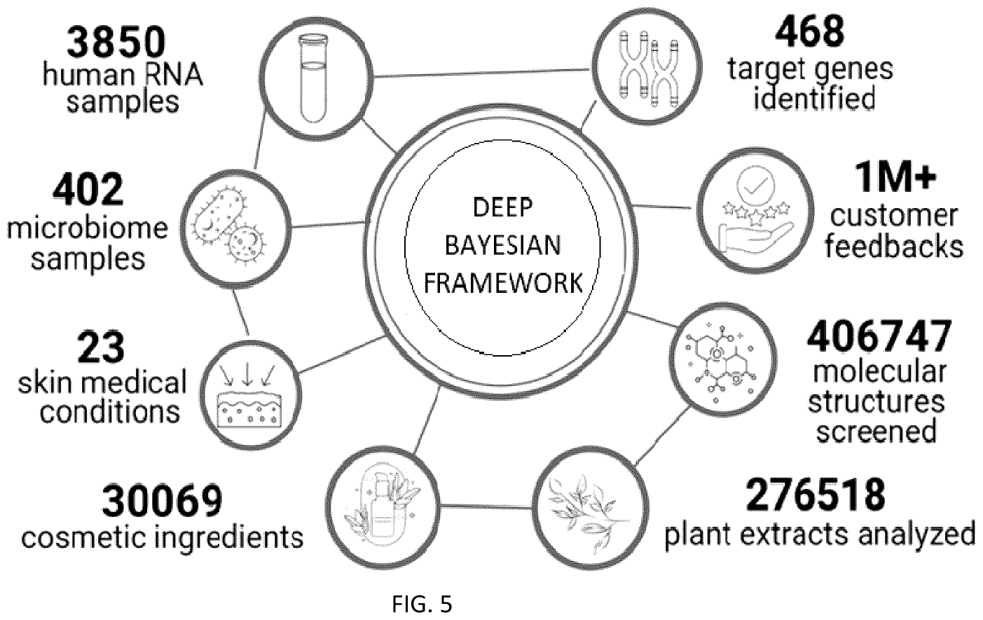

It is understood that by incorporating both a user-side and product side into the model a large plurality of data (as seen in FIG. 5) is combined to obtain reliable predictive power.

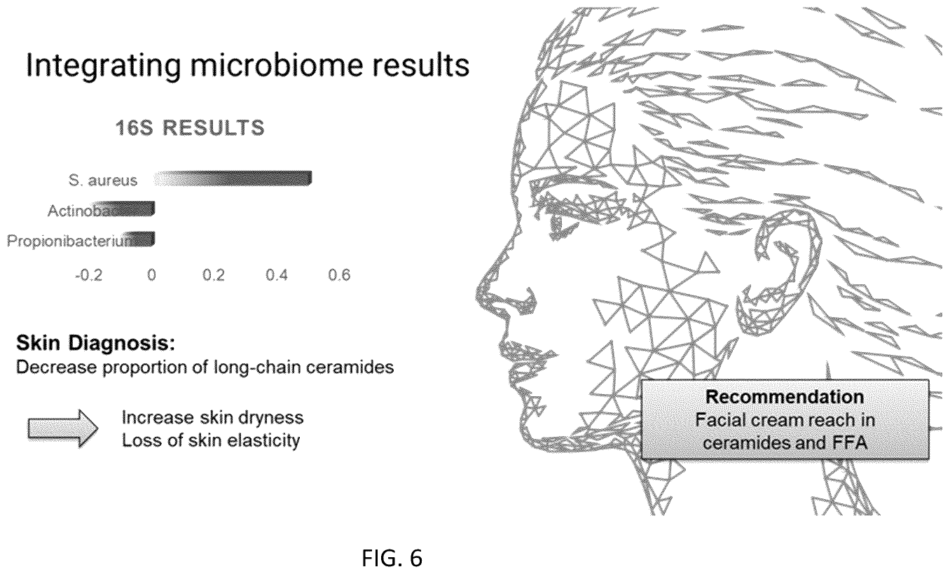

Reference is now made to FIG. 6, which schematically illustrates the integration of the host microbiome data into the AI-model for personalized matching of cosmetic/skincare/haircare products to a subject's ski/hair, according to some embodiments. The skin microbiome may have a direct effect on the skin and hair. As a non-limiting example, an individual with elevated presence of S. aureus (a staphylococcus may have an increased risk of developing atopic dermatitis). Low Actinobacteria and Propionibacterium levels on the other hand, may reduce long chain fatty acid concentration, and as a result reduce the concentration of long chain ceramides, leading to a loss of skin elasticity and wrinkles. Skincare products rich in ceramides and free fatty acids may thus be recommended, in order to restore the balance.

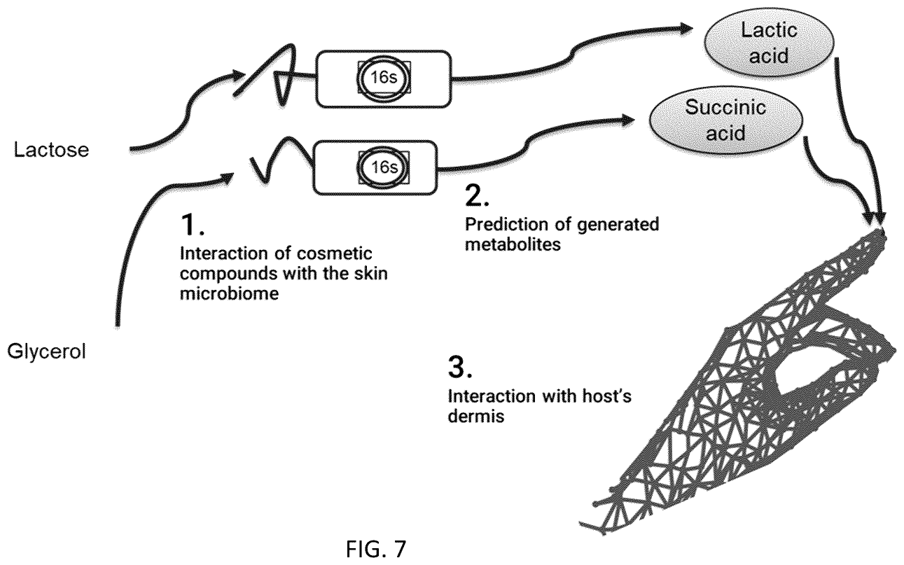

As illustrated in FIG. 7, the integration of the microbiome data also takes into account its indirect effects on the skin. That is, the microbiome is not only analyzed for its direct impact on the skin, but also in terms of how it affects the compounds in a potential cosmetic/skincare/haircare product, which in turn may impact the skin/hair. For example, if considering lactose and glycerol, two common ingredients of cosmetics cream, they can be transformed into lactic acid and succinic acid by the skin microbiota. Lactic acid and succinic acid have different impact on the skin, for example on atopic dermatitis, than the compounds from which they originated.

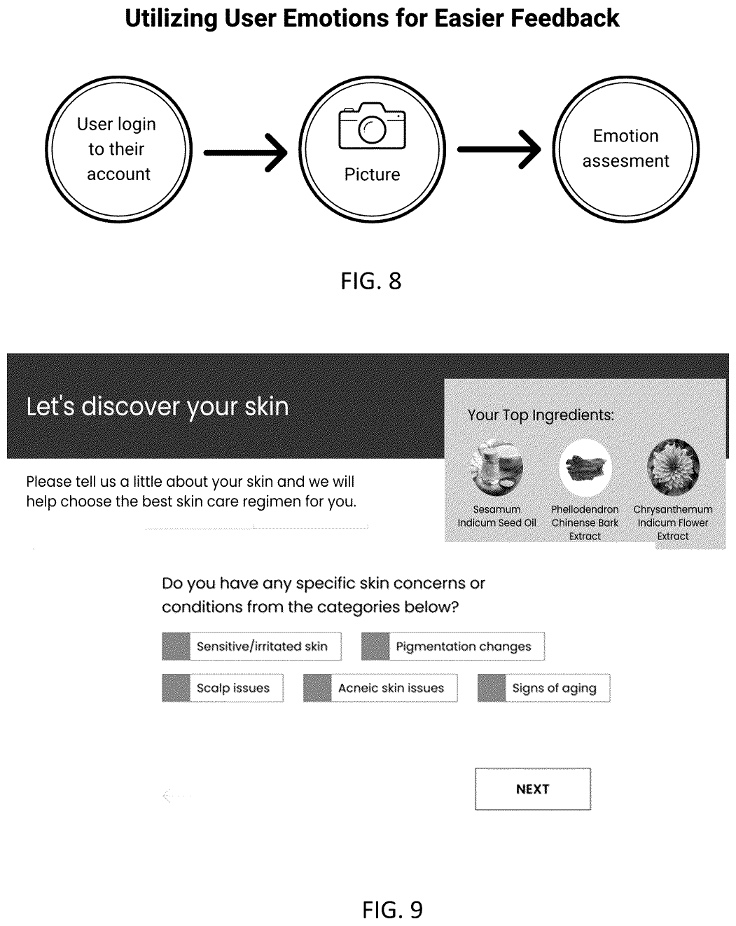

Reference is now made to FIG. 8, which schematically illustrates the integration of image-based user-feedback into the AI-model for personalized matching of cosmetic/skincare/haircare products to a subject's skin/hair, according to some embodiments. Getting feedback from the user in terms of satisfaction of the product is always a challenge as most users ignore feedback requests, and when feedback is given, there is a bias towards five stars review even when the users are not fully satisfied with the product. Product satisfaction and user content is therefore implemented by image-based emotion analysis. According to some embodiments, the image-based analysis comprises comparing pictures obtained over time, (e.g. at enrolment, immediately after product and one month after use), to obtain a non-biased and user-friendly feedback process. According to some embodiments, the emotion analysis may be used to guide the use of questionnaires, for example in terms of the length of the questionnaire and the type of questions applied. According to some embodiments, the emotion analysis may be used as an input to the AI-model in order to improve the satisfaction of products recommended in the future.

Reference is now made to FIG. 9, which schematically illustrates an optional question of a questionnaire. According to some embodiments, the subject may receive the questionnaire, via a user-interface. According to some embodiments, the questionnaire may be a standard questionnaire presented to all users, via the platform. According to some embodiments, the questionnaire may be personalized for example based on the physical/morphological features of the subject's skin/hair derived from the imaging, the medical/medicinal background of the subject, the environmental background and/or demographic data. According to some embodiments, the subject may initially receive a standard questionnaire and then later, based on the additional data received obtain a follow-up personalized questionnaire.

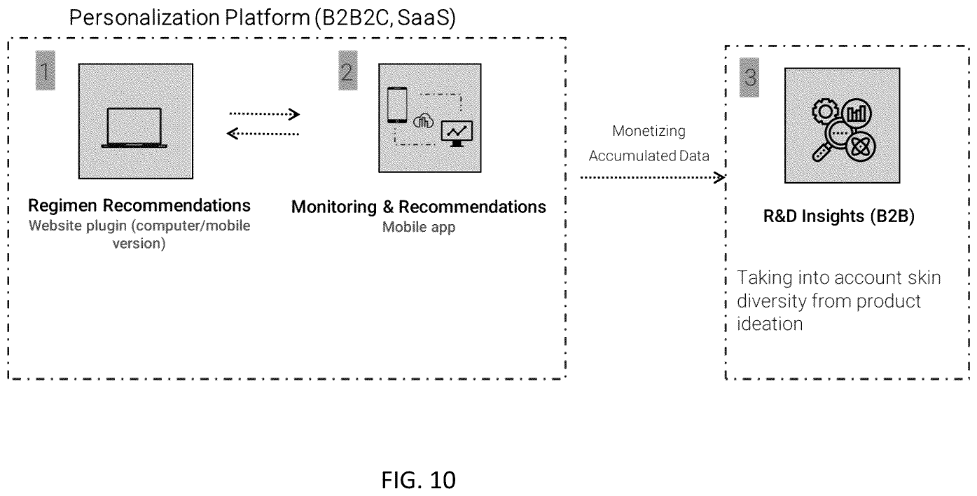

Reference is now made to FIG. 10, which schematically illustrates the extended use of the hereindisclosed platform for cosmetic/skincare/haircare regimen recommendation and monitoring and feedback as an input for research and development. According to some embodiments, the AI-model may be configured to monitor the status of the subject's skin/hair. According to some embodiments, the monitoring may include periodically requesting image capturing followed by an image analysis that allows a “before and after” comparison. According to some embodiments, the monitoring may include periodically presenting to the user a questionnaire (same or different), According to some embodiments, the monitoring may include periodically encouraging the user to do/redo biological test (e.g. microbiome analysis and/or DNA analysis) and the like. According to some embodiments, the monitoring may be used as input to the AI model so as to further improve its predictive value. According to some embodiments, a database summing up the results of a large plurality of users (preferably over 100 or over 200 users) may be created. According to some embodiments, a machine learning algorithm may be applied to retrieve the molecular properties of cosmetic, skin care and/or hair care products that are linked to success for improving the skin and/or hair of subjects having various skin types, hair types, skin conditions, hair conditions, skin problems, and/or scalp-related issues. Each possibility is a separate embodiment.

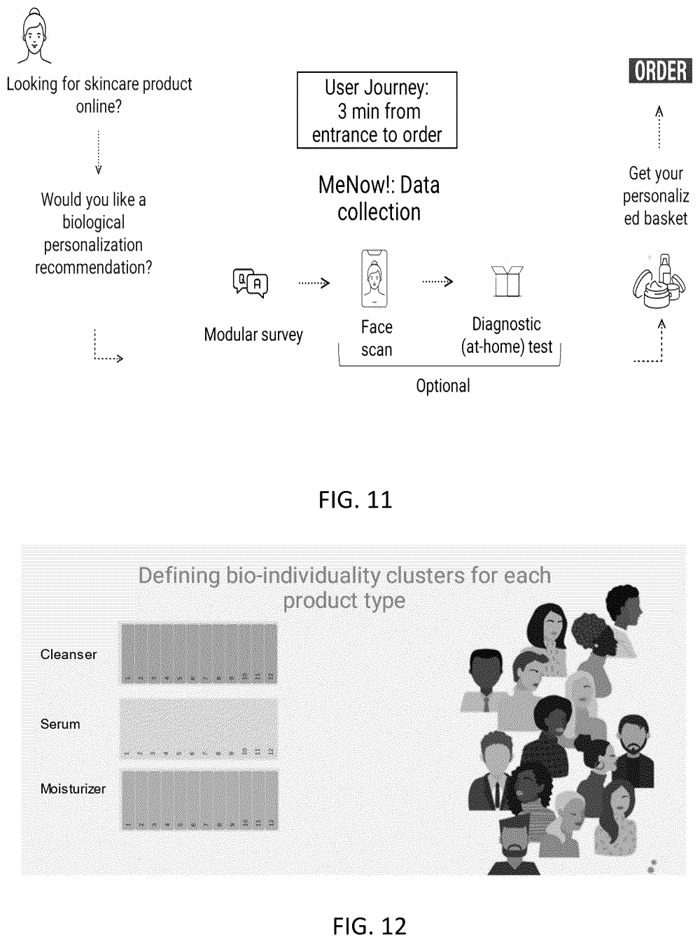

Reference is now made to FIG. 11, which schematically illustrates the hereindisclosed platform for matching of cosmetic/skincare/haircare products to a subject's skin/hair from an end-user's perspective, according to some embodiments. For example, an end user may go to a store (physical or digital) where he/she is confused due to the high number products available, even in a same product category. Using the herein described platform (e.g. an phone App), the end user fills an online skin/hair questionnaire and optionally uploads additional input data such as images of his/her skin/hair, test results of biological assays (e.g. microbiome tests, gene expression tests, genome analysis results, skin pH measurements and the like. The user may then:
1. Check the degree of matching of a specific selected skincare product; and/or
2. Be assigned to one or more bio-individuality clusters (as shown in FIG. 12), thus allowing him/her to easily identifies the good products among all of the available options in each category;
3. Receive a list of recommended products matching his/her skin/hair and/or matching the bio-individuality cluster to which he/she is assigned.

Advantageously, the clustering into bio-individuality clusters enables mass production of products while still taking into account the personal needs of each user.

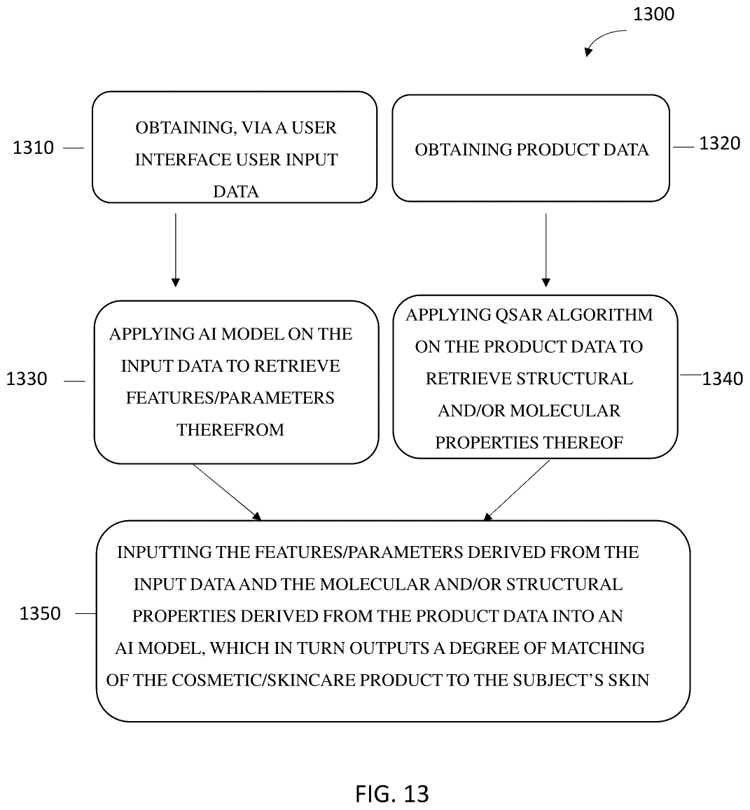

Reference is now made to FIG. 13, which is an illustrative flowchart of a computer implemented method 1300 for personalized matching of a skincare/haircare/cosmetic product to a subject's skin/hair, according to some embodiments.

In step 1310 user input data is obtained via a user interface (such as but not limited to an App or website). According to some embodiments, the user input data may include one or more of: answers to a questionnaire, environmental data, medical background, demographic data, one or more images of the subject's skin/hair, biological test data or any combination thereof. According to some embodiments, at least some of the data (e.g. images, biological test results etc.) may be uploaded to the App/website. According to some embodiments, at least some of the data may be inputted into the user interface by the user, e.g. by typing in, or selecting from a list of options presented to the user via the interface.

In parallel (simultaneously or sequentially), in step 1320, data regarding a cosmetic/skincare/haircare product may be obtained. According to some embodiments, the product data may include a name of the product, and optionally one or more of a brand of the product, a category of the product, a brand of the product, a price of the product or any combination thereof. Additionally or alternatively, the product data may include an ingredient list of the product. According to some embodiments, the product data may be typed in by the user. According to some embodiments, the product data may be retrieved from images of the product captured by the user. According to some embodiments, the product data may be retrieved from the label of the product. According to some embodiments, the product data may be retrieved by scanning a QR-code or a bar-code present on the product.

In step 1330, one or more AI models (feature extraction algorithms, NLP models, image analysis algorithms and the like) are applied on the user data to retrieve features/parameters therefrom.

In parallel (simultaneously, before or after), in step 1340, a Quantitative Structure-Activity Relationship (QSAR) algorithm is applied on the product data in order to retrieve/determine molecular and/or structural properties of the ingredients.

In step 1350, the features/parameters derived from the input data and the molecular and/or structural properties derived from the product data are input into an AI model, which in turn outputs a degree of matching of the cosmetic/skincare/haircare product to the subject's skin/hair.

In step 1360, the degree of matching of the cosmetic/skincare/haircare product to the subject's skin is transmitted/displayed to the user to thereby aid the user in choosing a right product for his/her skin/hair.

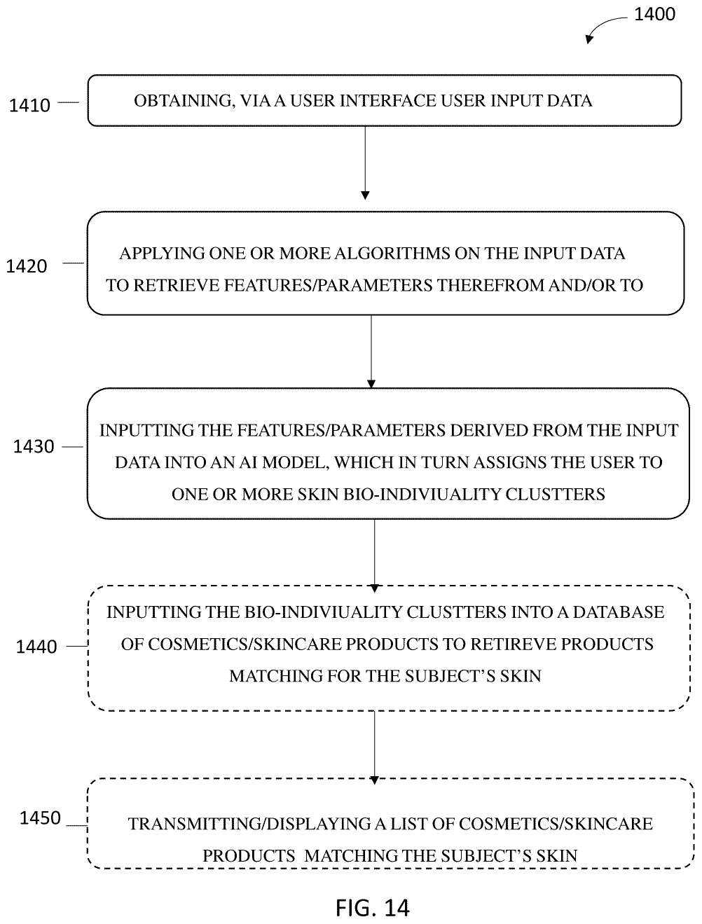

Reference is now made to FIG. 14, which is an illustrative flowchart of a computer implemented method 1400 for personalized matching of a skincare/haircare/cosmetic product to a subject's skin, according to some embodiments.

In step 1410 user input data is obtained via a user interface (such as but not limited to an App or website). According to some embodiments, the user input data may include one or more of: answers to a questionnaire, environmental data, medical background, demographic data, one or more images of the subject's skin/hair, biological test data or any combination thereof. According to some embodiments, at least some of the data (e.g. images, biological test results etc.) may be uploaded to the App/website. According to some embodiments, at least some of the data may be inputted into the user interface by the user, e.g. by typing in, or selecting from a list of options presented to the user via the interface.

In step 1420, one or more AI models (feature extraction algorithms, NLP models, image analysis algorithms and the like) are applied on the user data to retrieve features/parameters therefrom.

In step 1430, the features/parameters derived from the input data are input into an AI model, which in turn assigns the user to one or more skin/hair bio-individuality clusters. According to some embodiments, the one or more skin/hair bio-individuality clusters may be displayed to the user. According to some embodiments, the one or more skin/hair bio-individuality clusters may include at least two bio-individuality clusters, each cluster pertaining to a different product category.

In step 1440, the bio-individuality cluster of the user may optionally be inputted into a database of cosmetic/skincare/haircare products to retrieve cosmetic/skincare/haircare matching the user's skin/hair, and in step 1450 the list of matching products may be displayed/transmitted to the user. According to some embodiments, the cosmetic/skincare/haircare products in the database have previously been classified using a Quantitative Structure-Activity Relationship (QSAR) algorithm on the ingredients thereof. According to some embodiments, different separate lists may be produced for different product categories.

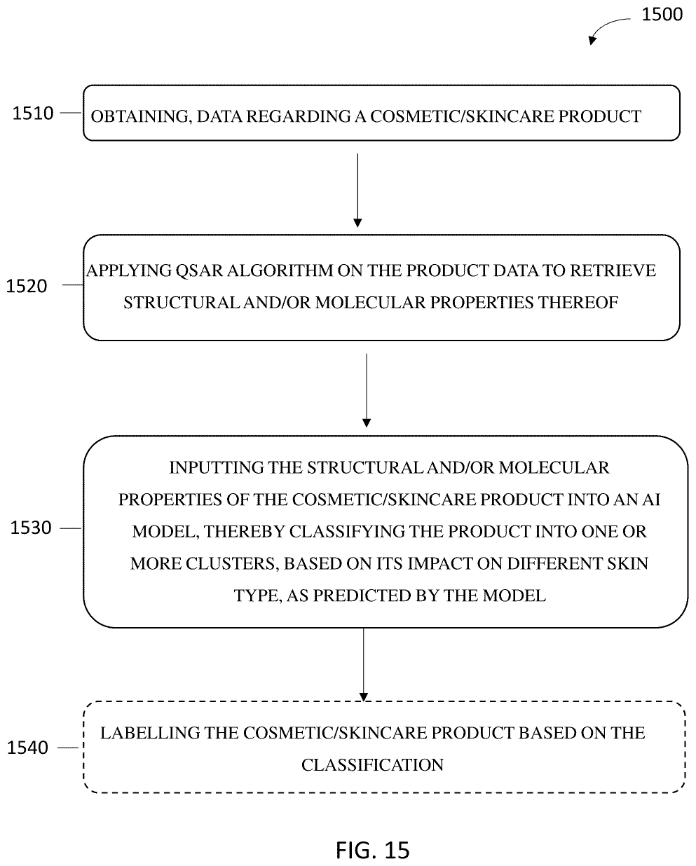

Reference is now made to FIG. 15, which is an illustrative flowchart of a computer implemented method 1500 for classification of a skincare/haircare/cosmetic product, according to some embodiments.

In step 1510, data regarding a cosmetic/skincare/haircare product is be obtained. According to some embodiments, the product data may include a name of the product, and optionally one or more of a brand of the product, a category of the product, a brand of the product, a price of the product or any combination thereof. Additionally or alternatively, the product data may include an ingredient list of the product. According to some embodiments, the product data may be typed in by a user. According to some embodiments, the product data may be retrieved from images of the product. According to some embodiments, the product data may be retrieved from the label of the product. According to some embodiments, the product data may be retrieved by scanning a QR-code or a bar-code present on the product.

In step 1520, a Quantitative Structure-Activity Relationship (QSAR) algorithm is applied on the product data in order to retrieve/determine molecular and/or structural properties of the ingredients.

In step 1530, inputting the molecular and/or structural properties derived from the product data into an AI model, to classify the product, based on the derived molecular and/or structural properties of the ingredients and the predicted impact on different skin types.

In step 1540, the cosmetic/skincare/haircare product is optionally labeled based on the classification, to thereby aid a user in choosing a right product for his/her skin/hair.

### EXAMPLES

### Example 1—Validation of Matching Between a Product's Ingredient List and a Skin Condition of a User Using the Hereindisclosed Platform

An evaluation of the ability of the herein disclosed platform to match between the ingredient list of a product and a skin condition of 42 participants was conducted in collaboration with AWS (Amazon Web Services) as part of an accelerator program. During this work, the effect of 14 natural skincare products (best-sellers from the Amazon website—www.amazon.com) including a total of 252 ingredients was compared with the subjective reviews given by the participants. An example result is shown in FIG. 4. Based on the ingredient list of the product, the tested facial cream was predicted to have positive effect on skin inflammation and acne for a specific part of the populations. However, for people at risk, it was predicted to potentially cause flare-ups of rosacea, a skin disease caused by the dilatation of blood vessels. Those results were further validated by analyzing reported positive and adverse effects from thousands of consumer reviews.

1. A computer-implemented method for personalized matching of a cosmetic, skincare and/or haircare product to a subject's skin/hair, the method comprising:
obtaining, via a user interface associated with a processor, input data of the subject, the input data comprising one or more of: answers to a questionnaire, environmental data, medical background, demographic data, one or more images of the subject's skin/hair, or any combination thereof;
extracting a plurality of subject-specific skin/hair and skin/hair associated features/parameters from the input data using text and/or image analysis algorithms,
obtaining, via input to the user interface, a name of a cosmetic, skincare and/or haircare product and/or a list of ingredients in a cosmetic, skincare and/or haircare product selected by the subject,
applying a Quantitative Structure-Activity Relationship (QSAR) algorithm on the ingredients in the selected cosmetic, skincare and/or haircare product, to obtain molecular and/or structural properties thereof,
applying, using the processor, an AI algorithm on the plurality of extracted subject-specific skin/hair and skin/hair-associated features/parameters and on the molecular and/or structural properties of the skincare, haircare and/or cosmetic product to determine a degree of matching of the selected cosmetic product to the subject's skin/hair; and
transmitting/displaying, via the user interface, the determined degree of matching the selected skincare, haircare and/or cosmetic product.

2. The method of claim 1, wherein the questionnaire is presented to the user via the user interface and the answers stored on a memory associated with the processor; and wherein the one or more images of the subject's skin/hair are uploaded to the processor via the user interface.

3. (canceled)

4. The method of claim 1, wherein the skin/hair features/parameters are selected from: oiliness, redness, dryness, skin diseases, inflammation of the skin, pigmentation, acne, scarring, rosacea, sunburns, wrinkles, skin elasticity, photoaging, seborrhea, dandruff, scalp-related issues, hair damages, hair dryness, hair oiliness, and any combination thereof and wherein the skin/hair-associated features/parameters are selected from: skin tone, age, gender, ethnicity, facial hair, hair thickness, hair type, hair color, emotions and any combination thereof.

5. (canceled)

6. The method of claim 1, further comprising updating the questionnaire based on the identified skin/hair features and/or skin/hair associated features.

7. The method of claim 1, wherein the user data further comprises a microbiome profile and/or DNA profile of the subject, and/or a pH measured for the subject's skin and/or oiliness measured for the subject's skin.

8. (canceled)

9. The method of claim 1, wherein the environmental parameters are selected from one or more of temperature, sun radiation, air pollution, humidity, UV index and any combination thereof.

10. The method of claim 1, wherein the medical parameters are selected from one or more of allergies, medical history, menstrual cycle, pregnancy and any combination thereof.

11. The method of claim 1, wherein the AI algorithm comprises a Bayesian network.

12. The method of claim 1, wherein the cosmetic product is a facial skincare product.

13. The method of claim 1, wherein the input data comprises answers to a questionnaire and one or more of: environmental data, medical background, demographic data, one or more images of the subject's skin, or any combination thereof.

14. A computer-implemented method for matching cosmetic, skincare and/or haircare product to a subject's skin/hair, the method comprising:
obtaining, via a user interface associated with a processor, input data of the subject, the input data comprising one or more of: answers to a questionnaire, environmental data, medical background, demographic data, one or more images of the subject's skin/hair, or any combination thereof;
extracting a plurality of subject-specific skin/hair and skin/hair associated parameters/features from the input data using text and/or image analysis algorithms;
applying, using the processor, an AI algorithm on the plurality of extracted skin/hair and skin/hair associated features/parameters, to assign the subject into one or more skin/hair bio-individuality clusters;
inputting the one or more skin/hair bio-individuality clusters into a database of cosmetic, skincare and/or haircare products to output a list of cosmetic, skincare and/or haircare products that match the subject's skin, wherein the one or more skin type clusters indicates recommended and/or unrecommended cosmetic, skincare and/or haircare product ingredients; and
transmitting/displaying, via the user interface, the list of matching cosmetic, skincare and/or haircare products to the subject.

15. The method of claim 14, wherein the method is further configured to transmit to the subject the list of recommended and/or unrecommended skin/hair product ingredients.

16. The method of claim 14, wherein the cosmetic products in the database are classified using a Quantitative Structure-Activity Relationship (QSAR) algorithm on the ingredients thereof.

17. The method of claim 14, wherein the AI algorithm is further configured to determine a degree of matching of the listed-as-matching cosmetic, skincare and/or haircare products and transmitting the degree of matching to the subject.

18. The method of claim 14, further comprising obtaining, via a user provided input, one or more product categories of interest, and wherein the clustering is category specific, and wherein the one or more product categories are selected from cleansing products, serums, moisturizers, sunscreens, masks, conditioners, fragrances, make-ups, concealers, and any combination thereof.

19. (canceled)

20. The method of claim 14, wherein the skin features/parameters are selected from: oiliness, redness, dryness, skin diseases, scalp-related issues, inflammation of the skin, pigmentation, acne, scarring, sunburns, atopic dermatitis, rosacea, seborrhea, dandruff and any combination thereof; and wherein the skin-associated features/parameters are selected from: skin tone, age, gender, age, ethnicity, facial hair, hair color, hair type, emotions and any combination thereof.

21. (canceled)

22. The method of claim 14, wherein the AI algorithm comprises a Bayesian network.

23. (canceled)

24. The method of claim 14, wherein the input data comprises answers to a questionnaire and one or more of: environmental data, medical background, demographic data, one or more images of the subject's skin, or any combination thereof.

25. (canceled)

26. A platform for matching cosmetic, skincare and/or haircare products to a subject's skin/hair, the platform comprising:
a user interface, the user interface configured to:
receive via upload or user input, input data of the subject, the user data comprising one or more of: answers to a questionnaire, environmental data, medical background, demographic data, one or more images of the subject's skin/hair, or any combination thereof; and
a processor, associated with the user interface, the processor configured to:
extract a plurality of subject-specific skin and skin associated parameters/features from the input data using text and/or image analysis algorithms;
apply an AI algorithm on the plurality of extracted skin/hair and skin/hair-associated features/parameters, to assign the subject into one or more skin/hair bio-individuality clusters;
input one or more of the assigned bio-individuality cluster into a database of cosmetic, skincare and/or haircare products to output a list of matching cosmetic, skincare and/or haircare products and/or a list of recommended ingredients of cosmetic, skincare and/or haircare products; and
transmitting, via the user interface, the list of suitable cosmetic, skincare and/or haircare products and/or list of recommended ingredients in the etic, skincare and/or haircare products to the subject.

27. The platform of claim 26, wherein the database of etic, skincare and/or haircare products comprises etic, skincare and/or haircare products analyzed by applying a Quantitative Structure-Activity Relationship (QSAR) algorithm thereon, to derive molecular properties thereof.
